(19) United States
(12) Patent Application Publication
(10) Pub. No.: US 2007/0053532 A1
(43) Pub. Date: Mar. 8, 2007

(54) Sound reproduction systems for use by adjacent users

(76) Inventors: Stephen John Elliott, Highfield (GB); Husam Abulula, Highfield (GB); Teresa Bravo-Maria, Highfield (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/560,412

(22) PCT Filed: Jul. 1, 2004
(86) PCT No.: PCT/GB04/02839

§ 371 Date: Jul. 14, 2006

(30) Foreign Application Priority Data
Jul. 1, 2003 (GB) 0315342.6

(51) Int. Cl. H04R 5/02

(52) U.S. Cl. 381/302

(57) ABSTRACT

A sound reproduction system for providing sound to adjacent users comprises first and second speaker means positioned respectively adjacent to the intended head positions of first and second users. Each speaker means comprises a pair of speakers, one of which (q, p) faces inwards towards the head position (po) of the user, the other of which faces outwards generally towards the head position (p1) of the second user. Filter means H₁ control the input to the outwardly facing speaker (qs1) relative to the input applied to the inwardly facing speaker (qp) so as to reduce the sound that would be perceived by the second user due to the first speaker means (qp). The filter means (H₁) may provide a delayed and weighted version of the signal input to it. A sound reproduction system alternatively comprises a feedforward compensating filter means (H₁, H₂) having an input connected to the first speaker means (q2) and an output connected to the second speakers means (q1) configured to provide the second speaker means (q1) with a modified version of the signals fed to the first means and so reduce the sound perceived by the second user (p5) as emitted by the first speaker means (q2).

The present invention relates to sound reproduction systems for use by adjacent users, and relates particularly, but not exclusively, to systems employing headrest loudspeakers in the headrests of adjacent vehicle seats.

When two people are listening to different audio signals in adjacent seats in an aircraft or road vehicle, each person wants to hear their own audio signal faithfully reproduced, with a minimum of interference from the other person's audio signal.

### Introduction

In this specification two methods will be discussed that can substantially isolate the acoustic environments of two people in adjacent seats, when the sound is reproduced through loudspeakers in the seat headrests. In the first method, feedforward control techniques are used to minimise the sound from the loudspeakers on one seat at the position of the adjacent person using the loudspeakers on the second seat as secondary sources. In the second method an array of acoustic sources is used to generate a large pressure in one region of their nearfield, to reproduce the sound for one person, but to minimise the sound pressure in another region, corresponding to the position of the adjacent person. Numerical simulations of the performance of both these techniques are presented below for simplified acoustic models in the free-field.

According to one aspect of the invention we provide a sound reproduction system for providing sound to two adjacent first and second users, the system comprising first speaker means positioned adjacent to the intended head position of the first user, and second speaker means positioned adjacent to the intended head position of the second user, a first channel connected to the first speaker means to enable, in use, the first user to listen to sound conveyed by said first channel, and a second channel connected to the second speaker means to enable, in use, the second user to listen to sound conveyed by said second channel, and a feedforward compensating filter means (H₁, H₂) having an input connected to the inputs to the first speaker means, and an output connected to the input to the second speaker means, the compensating filter means being so configured as to provide to the second speaker means a modified version of the signals being fed on said first channel to the first speaker means, said compensating filter means (H₁, H₂) having been determined to reduce the sound that would be perceived by the second user to have been emitted by the first speaker means.

Preferably the filter means (H₁, H₂) has been determined by calculating the vector of complex pressures p=[p₁p₂]^{T} using an equation of the form p=pₚ+Zqₛ where pₚ is the pressure at the head position of the second user due to the primary sound source of said first speaker means, and Z is the matrix of acoustic impedances between p and qₛ of the second speaker means, and qₛ=q_{s,opt}=−Z⁻¹pₚ where the complex volume velocities of the speakers of the second speaker means are qₛ=[qₛ₁qₛ₂]^{T}.

One method of designing the compensating filter means is to adjust adaptive filters in an error minimisation filter design procedure, such as that discussed in patent specification EP 0434691A.

Conveniently the first and second speaker means are mounted on or in first and second adjacent head rest assemblies but they could be mounted in other panel structures adjacent to the user head positions.

The speaker means preferably each comprise right and left speakers which are situated in use adjacent to the right and left sides of the respective user's head.

The speaker means are preferably housed in wings of the headrest, the speakers facing generally towards the respective head positions.

According to a second aspect of the invention we provide a sound reproduction system for providing sound to two adjacent first and second users, the system comprising first and second speaker means positioned respectively adjacent to the intended head positions of the first and second users, each speaker means comprising a pair of speakers one of which faces inwards towards the head position of the first user, and the other faces outwards from said head position and generally towards the intended head position of the second user, filter means (H₁) controlling the input to the outwardly facing speaker relative to the input applied to the inwardly facing speaker, the filter means (H₁) being designed by adjusting the filter coefficients thereof so as to reduce the sound that would be perceived by the second user due to the first speaker means.

The filter means may be designed by adjusting the filter coefficients thereof so as to maximise the ratio of the mean square pressures in the zone occupied in use by the head of the first user relative to the mean square pressures in the zone occupied in use by the head of the second user.

The inwardly and outwardly facing speakers of the first speaker means are used as a nearfield array, and the filter means H, is configured to reproduce sound signals at the head of the first user but to attenuate this signal at the head of the second user.

The filter means may be designed by adjusting adaptive filters in an error minimisation filter design procedure.

A convenient technique for designing the filter means (H₁) is by adjusting the filter coefficients such that the pressure, or the mean pressure, at one or more discrete locations in the region of the second head position, at a particular frequency, due to sound emitted by the first and second speakers, is substantially zero.

A convenient embodiment of the filter means (H₁) is one which provides a delayed and weighted version of the signal input to the filter means.

Then, a flatter frequency response can be achieved with a pre-conditioning filter means (H₂) provided in the inputs to said pair of speakers, the pre-conditioning filter means (H₂) being configured to adjust the frequency response.

Preferably the pre-conditioning filter means (H₂) is substantially of the form H₂=(1−Re^{-jωτ})⁻¹ where R<1.

Some embodiments of the invention will now be described, by way of example only, with reference to the accompanying drawings in which:

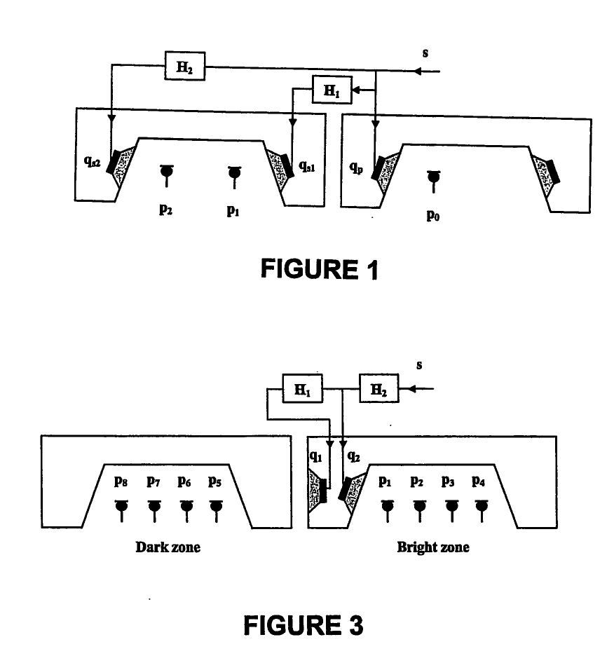

FIG. 1 shows the physical arrangement of the headrests for two adjacent seats with a feedforward system configured in accordance with the invention to control the sound from a loudspeaker in the right headrest, due to audio signal s, being heard by a listener on the left headrest;

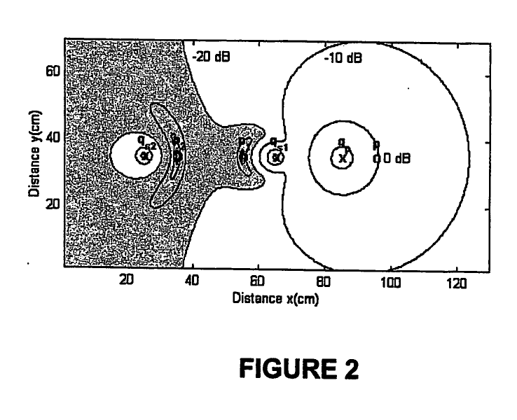

FIG. 2 shows contour plots of the pressure at 400 Hz from a free-field acoustic model after feedforward control of the pressure due to source qₚ at p₁ and p₂ on the left hand side using secondary sources qₛ₁ and qₛ₂;

FIG. 3 shows a physical arrangement in which two loudspeakers with volume velocities q₁ and q₂ are used in accordance with the invention as a nearfield array to reproduce a signal at p₁, p₂, p₃ and p₄, but to attenuate this signal at p₅, p₆, p₇ and p₈;

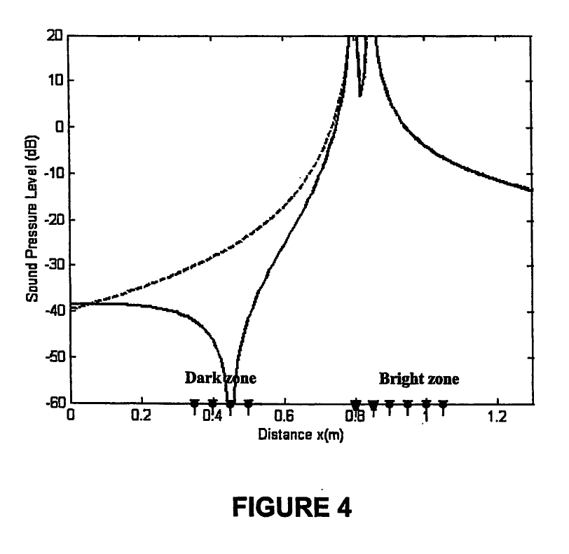

FIG. 4 shows the pressure level generated along the x axis by two monopole sources whose source strength is adjusted to maximise the contrast between the mean square pressure in the bright zone and the dark zone (solid line), and that generated by the two monopoles when adjusted to cancel the farfield pressure to the left of the array (dashed line);

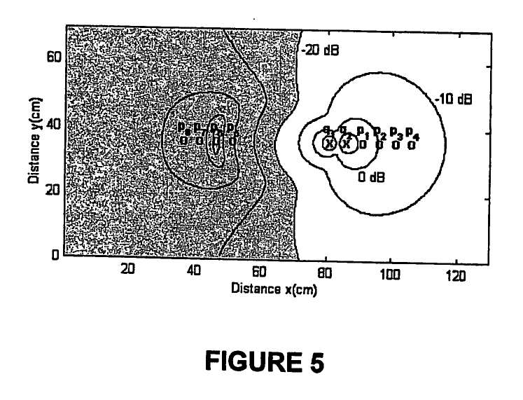

FIG. 5 shows distribution of pressure level over the x-y plane generated by the two monopole sources in FIG. 3;

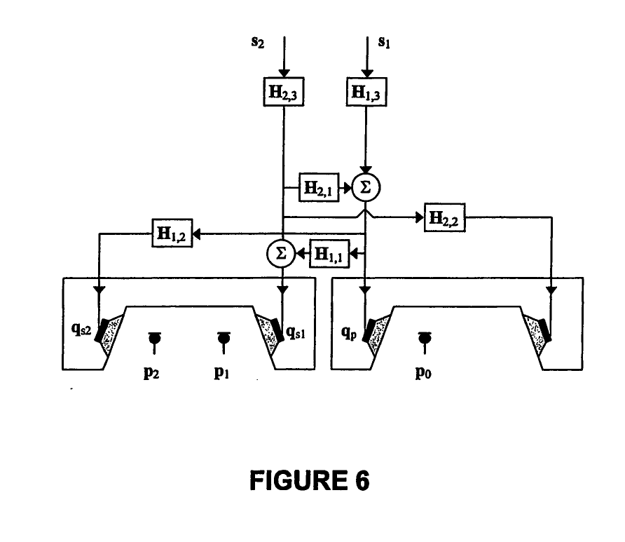

FIG. 6 shows cross-compensation in an arrangement in accordance with the invention, and similar to that of FIG. 1, in which the sound from a loudspeaker in the right headrest is controlled at the left headrest by the filters H_{1.1} and H_{1.2}, the sound from a loudspeaker in the left headrest is controlled at the right headrest by the filters H_{2.1} and H_{2.2}, and the overall acoustic response at the right and left headrests are equalised by the filters H_{1.3} and H_{2.3} respectively; and

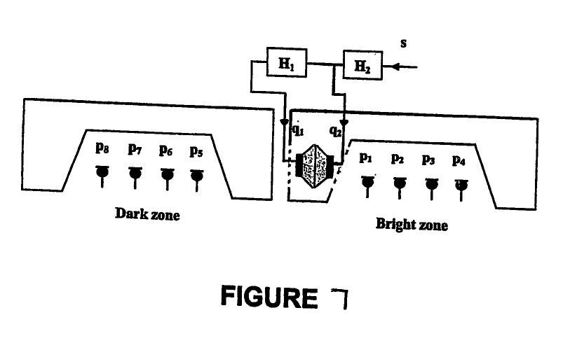

FIG. 7 shows a physical arrangement of a nearfield array in accordance with the invention and similar to that of FIG. 3 but in which the two loudspeakers making up the array are positioned facing one another.

### ACTIVE CONTROL

With reference to FIG. 1, since the signals being fed into the loudspeakers on one headrest are known, they can be used as reference signals in a feedforward system¹ to control the sound at the adjacent seat, using the loudspeakers in that seat as secondary sources². The physical arrangement for one channel of such a system is shown in FIG. 1. If the vector of complex pressures at a single frequency in the left hand seat is p=[p₁p₂]^{T} and the complex volume velocities of the two sources on this seat are qₛ=[qₛ₁qₛ₂]^{T}, then
p=pₚ+Zqₛ (1)

where pₚ is the pressure due to the primary source in the right hand seat and Z is the matrix of acoustic impedances between p and qₛ. These pressures are cancelled if
qₛ=q_{s,opt}=−Z⁻¹pₚ (2)

The pressure at other positions in the field can then be calculated.

FIG. 2 shows the resulting sound pressure level contours from a free-field simulation of the system of FIG. 1 at 400 Hz, in which both the single primary source, in the left-hand headrest, and the two secondary sources in the right-hand headrest, were modelled as monopoles. The shaded area denotes the region within which the level is at least 20 dB below the level at the ear of the listener in the right-hand headrest. Although this region would enclose the head of a person in the left-hand headrest at 400 Hz, it becomes much smaller at higher frequencies, particularly above about 600 Hz, due to the poor spatial matching of the pressure field from the two secondary sources and that from the primary source, since their separation is comparable with the wavelength³.

FIG. 6 shows how filters H₁ and H₂ can be used to provide compensation in both head positions.

### Nearfield Arrays

Although arrays of loudspeakers can be used to generate highly directional soundfields using beamforming techniques⁴, this directivity is generally evaluated in the far field of the sources⁵. The design of a near field loudspeaker array however has more in common with the design of near field microphones⁶ than far field loudspeaker arrays. The physical arrangement of such an array using two loudspeakers on one side of a headrest is shown schematically in FIG. 3.

One approach to the design of such an array is to maximise the ratio of the mean square pressures in the zone where sound is to be reproduced and the zone where sound is to be attenuated. This problem has been considered recently by Choi and Kim⁷ who termed the two regions of space the “bright zone” and the “dark zone” respectively. The principle of the optimisation may be illustrated in the frequency domain. The vector of complex pressures over a grid of points at a single frequency in the bright zones, p_{B}, is equal to p_{B}=Z_{B}q, where q is the vector of complex strengths of the sources in the array and Z_{B} is the matrix of complex acoustic impedances determined by the geometry and acoustic environment. Similarly, the vector of complex pressures at a grid of points in the dark zone is equal to p_{D}=Z_{D}q, where Z_{D} is the corresponding matrix of acoustic impedances. The ratio of the sum of the squared pressures in the bright zone and the dark zone is defined to be the “contrast”,

$$C = \frac{{‖ {p}_{B} ‖}^{2}}{{‖ {p}_{D} ‖}^{2}} = \frac{{q}^{H} {Z}_{B}^{H} {Z}_{B} q}{{q}^{H} {Z}_{D}^{H} {Z}_{D} q} . \qquad ( 3 )$$

The contrast is maximised if the vector of source strengths in the array, q, is equal to the eigenvector of the matrix [Z_{D}^{H}Z_{D}]⁻¹Z_{B}^{H}Z_{B} corresponding to its largest eigenvalue.

We have performed some preliminary free-field calculations for an array of two acoustic sources, 5 cm apart, with four points in a bright zone on the right of the axis of the array, spaced 5, 10, 15 and 20 cm from the closest loudspeaker, and four points in a dark zone on the left of the array, spaced 30, 35, 40 and 45 cm from the closest loudspeaker. These dimensions were motivated by the headrest geometry in which one music signal is to be reproduced for a listener on the right, but the listener on the left wants to listen to another music signal and does not want the interference from the first signal. The pressure field along the axis of the array after maximisation of the contrast at 400 Hz is shown in FIG. 4, which also shows the geometric arrangement of the array and monitoring positions. The contrast has a level of about 46 dB in this case, compared with a contrast level of about 14 dB obtained if only a monopole source was used or 16 dB with a dipole source. The dashed line in FIG. 4 shows the pressure distribution when the source strengths in the array are adjusted to cancel the farfield pressure to its left. This creates a perfect null in the farfield directivity pattern, but the nearfield contrast level is then only about 28 dB, some 18 dB less than that of the nearfield array. A contour plot of the pressure level over a two-dimensional plane cutting through the array is shown in FIG. 5. Although the pressure has only been optimised along a line at y=0.35 m, running parallel to the x axis, the source array produces a sensible pressure distribution at other locations, gradually falling away on either side of the array but producing a reasonably uniform field at points in the immediate vicinity of the bright zone. The shape of this pressure distribution is fairly independent of frequency up to several kilohertz, but becomes progressively smaller at higher frequencies.

By redefining the points in the bright and dark zones other pressure distributions could be obtained, but FIG. 5 demonstrates that useful pressure distributions can be obtained with rather simple arrays.

FIG. 7 shows a modification, in accordance with the invention, to the array of FIG. 3, in which the two loudspeakers with volume velocities q₁ and q₂ are positioned with the cones of the speakers facing each other, so that the sound is radiated by the backs of the diaphragms. This arrangement is relatively compact and potentially more practical than the back-to-back design shown in FIG. 3. The portion of the headrest shown by broken lines is made of an acoustically transparent material.

The loudspeakers cones may be separated by a rigid diaphragm in order to prevent the vibration of one affecting the other. This is not necessary, however, as any such transmitted vibration will be measured in the electrical versions of the acoustic impedances Z_{D} and Z_{B} and so will be accounted for in the calculation of the filter. In fact, the system may be more efficient if there is not a barrier between the cones, since less voltage may be required to drive the second loudspeaker. While it is advantageous that the two loudspeakers are positioned as close as possible, as an alternative they could be positioned with the cones separated if required.

### Pressure Cancellation

The pressure distribution obtained by maximising the contrast for the geometry considered in FIG. 3 is almost identical to that obtained if the source strengths are adjusted to cancel the pressure p6. The complex pressure at this position due to the two monopole sources, q₁ and q₂ may be written as
p₆=Z₆₁q₁+Z₆₂q₂, (4)

where Z₆₁ and Z₆₂ are the acoustic impedances from q₁ and q₂ to p₆. In order for p₆ to be zero, the ratio of the two source strengths must obey the equation

$$\frac{{q}_{1}}{{q}_{2}} = - \frac{{Z}_{62}}{{Z}_{61}} = - \frac{{r}_{61}}{{r}_{62}} {ⅇ}^{- j k ( {r}_{62} - {r}_{61} )} , \qquad ( 5 )$$

where the final expression has been derived by assuming freefield conditions and r₆₁ and r₆₂ are the distances from q₁ and q₂ to p₆. Equation (5) suggests that pressure distributions almost identical to the one above could be produced by driving q₂ with the signal to be reproduced and then driving q₁ with a delayed and weighted version of this signal.

The pressure produced at, say, p₂ in the bright zone can be written using similar notations to that above as
p₂=Z₂₁q₁+Z₂₂q₂, (6)

so that if q₁ and q₂ are related by equation (5), then in general

$$\frac{{p}_{2}}{{q}_{2}} = {Z}_{22} ( 1 - \frac{{Z}_{21} {Z}_{62}}{{Z}_{22} {Z}_{61}} ) , \qquad ( 7 )$$

which for the case of freefield propagation is equal to

$$\frac{{p}_{2}}{{q}_{2}} = {Z}_{22} ( 1 - R {ⅇ}^{- j ω r} ) \qquad ( 8 )$$

where R=r₆₁r₂₂/r₆₂r₂₁, which is equal to about 0.58 for the geometry used above and τ=(r₆₂−r₆₁+r₂₁−r₂₂)/c₀, which is equal to about 0.3 ms for the geometry used above. Since R<1, the frequency response (1−Re^{-jωτ}) is minimum phase and thus has a causal inverse, which could be used to precompensate the signal to be reproduced at p₂ before it was fed to q₂. An arrangement for driving q₁ and q₂ from a signal s, which would result in uniform reproduction at p₂ and cancellation at p₆ is shown in FIG. 3, in which H₁ is given by equation (5) and H₂=(1−Re^{-jωτ})⁻¹.

Although this arrangement will cancel the pressure at p₆, the sum of squared pressures in the dark zone, and hence the overall contrast, will still vary somewhat as a function of frequency. The contrast increases from about 43 dB at low frequencies, to about 52 dB at 1700 Hz, when the combination of the inversion and the 90° phase shift in H₁ at this frequency, and the 90° phase shift due to the propagation from q₁ to q₂ ensure that the pressure due to q₁ is in phase with that due to q₂ in the bright zone, boosting the response relative to the dark zone.

### SUMMARY

Active feedforward control of sound in adjacent seats appears to work well for frequencies up to about 500 Hz, but the zone of quiet then becomes rather small. The nearfield array appears to give good acoustic isolation between the seats up to several kilohertz.

### REFERENCES

1. P A Nelson, S J Elliott, Active Sound Control. (Academic Press, 1992)
2. H Hashimoto et al., “Active noise control for the seat audio system”, Proc. ACTIVE95, 1279-1290 (1995)
3. J Garcia-Bonito, S J Elliott, “Local active control of diffracted soundfields”, J. Acoust. Soc. Am., 98, 1017-1024 (1995)
4. D L Smith, “Discrete-element line arrays—their modelling and optimisation”, J. Audio Eng. Soc., 45, 949-964 (1997)
5. W F Druyvesteyn, J Garas, “Personal sound”, J. Audio Eng. Soc., 45(9), 685-701 (1997)
6. L Beranek, Acoustics (McGraw Hill, 1954).
7. J-W Choi, Y-H Kim, “Generation of an acoustically bright zone with an illuminated region using multiple sources”, J. Acoust. Soc. Am., 444(11), 1695-1700 (2002)

1. A sound reproduction system for providing sound to two adjacent first and second users, the system comprising first and second speaker means positioned respectively adjacent to the intended head positions of the first and second users, each speaker means comprising a pair of speakers one of which faces inwards towards the head position of the first user, and the other faces outwards from said head position and generally towards the intended head position of the second user, filter means (H₁) controlling the input to the outwardly facing speaker relative to the input applied to the inwardly facing speaker, the filter means (H₁) being designed by adjusting the filter coefficients thereof so as to reduce the sound that would be perceived by the second user due to the first speaker means.

2. A sound reproduction system as claimed in claim 1 in which the filter means (H₁) has been designed by adjusting the filter coefficients thereof so as to maximise the ratio of the mean square pressures in the zone occupied in use by the head of the first user relative to the mean square pressures in the zone occupied in use by the head of the second user.

3. A sound reproduction system as claimed in claim 2 in which the filter means (H₁) has been designed by minimisation of the mean square pressures at an array of points in the zone to be occupied by the head of the second user.

4. A sound reproduction system as claimed in claim 1 in which the filter means has been designed by adjusting adaptive filters in an error minimisation filter design procedure.

5. A sound reproduction system as claimed in claim 1 in which the filter means (H₁) has been designed by adjusting the filter coefficients such that the pressure, or the mean square pressure, at one or more discrete locations in the region of the second head position, at a particular frequency, due to sound emitted by the first and second speakers, is substantially zero.

6. A sound reproduction system as claimed in claim 5 in which the filter means (H₁) provides a delayed and weighted version of the signal input to the filter means.

7. A sound reproduction system as claimed in claim 5 which a pre-conditioning filter means (H₂) is provided in the inputs to said pair of speakers, the pre-conditioning filter means (H₂) being configured to adjust the frequency response of the overall system, as experienced by the first user.

8. A sound reproduction system as claimed in claim 7 in which the pre-conditioning filter means (H₂) is substantially of the form H₂=(1−Re^{-jωτ})⁻¹ where R<1.

9. A sound reproduction system for providing sound to two adjacent first and second users, the system comprising first speaker means positioned adjacent to the intended head position of the first user, and second speaker means positioned adjacent to the intended head position of the second user, a first channel connected to the first speaker means to enable, in use, the first user to listen to sound conveyed by said first channel, and a second channel connected to the second speaker means to enable, in use, the second user to listen to sound conveyed by said second channel, and a feedforward compensating filter means (H₁, H₂) having an input connected to the inputs to the first speaker means, and an output connected to the input to the second speaker means, the compensating filter means being so configured as to provide to the second speaker means a modified version of the signals being fed on said first channel to the first speaker means, said compensating filter means (H₁, H₂) having been determined to reduce the sound that would be perceived by the second user to have been emitted by the first speaker means.

10. A sound reproduction system as claimed in claim 9 in which the filter means (H₁, H₂) has been determined by calculating the vector of complex pressures p=[p₁p₂]^{T} using an equation of the form p=pₚ+Zqₛ where pₚ is the pressure at the head position of the second user due to the primary sound source of said first speaker means, and Z is the matrix of acoustic impedances between p and qₛ of the second speaker means, and qₛ=q_{s,opt}=−Z⁻¹pₚ where the complex volume velocities of the speakers of the second speaker means are qₛ=[qₛ₁qₛ₂]^{T}.

11. A sound reproduction system as claimed in claim 9 in which the compensating filter means has been determined by adjusting adaptive filters in an error minimisation filter design procedure.

12. A sound reproduction system as claimed in claim 9 in which the first and second speaker means are mounted on or in first and second adjacent headrest assemblies.

13. A sound reproduction system as claimed in claim 9 in which each of said speaker means comprises respective right and left speakers positioned in use adjacent to the right and left sides of the user's head.

14. A sound reproduction system as claimed in claim 13 in which the compensating filter means is adapted to receive a signal that is fed to only one of the speakers of the first speaker means, said one speaker being the speaker that is closer to the second speaker means.

15. A sound reproduction system as claimed in claim 13, in which the speaker means are housed in wings of the headrest, the speakers facing generally towards the respective head positions.

16. A sound reproduction system as claimed in claim 9 in which the compensating filter means (H₁, H₂) comprises a series of filter coefficients calculated for a range of frequencies extending up to about 400 Hz.

17. A sound reproduction system as claimed in claim 9 in which the compensating filter means (H₁, H₂) comprises a series of filter coefficients calculated for a range of frequencies extending up to about 600 Hz.
